(19) United States
(12) Patent Application Publication
(10) Pub. No.: US 2026/0032741 A1
(43) Pub. Date: Jan. 29, 2026

(54) USING A USER EQUIPMENT WITH A TELECOMMUNICATIONS NETWORK, WHEREIN THE USER EQUIPMENT REQUESTS, WHILE BEING CONNECTED TO THE TELECOMMUNICATIONS NETWORK, TO BE CONNECTED TO OR TO ACCESS A FURTHER NETWORK

(71) Applicant: Deutsche Telekom AG, Bonn (DE)

(72) Inventor: Josep COLOM IKUNO, Korneuburg (AT)

(21) Appl. No.: 19/138,687

(22) PCT Filed: Dec. 4, 2023
(86) PCT No.: PCT/EP2023/084133

§ 371 Date: Jun. 13, 2025

(30) Foreign Application Priority Data
Jan. 2, 2023 (EP) 23150013.3

(51) Int. Cl. H04W 76/12; H04L 61/4511; H04W 60/04; H04W 72/12

(52) U.S. Cl. CPC H04W 76/12; H04L 61/4511; H04W 60/04; H04W 72/12

(57) ABSTRACT

A method for using a user equipment with a telecommunications network includes: the user equipment requests a communication session to be established to or towards a further network, using a target network identifier information as part of a request message being transmitted, by the user equipment, to a control plane function of the telecommunications network; the communication session is associated to a data network and/or data network name in order to provide connectivity towards the further network via cloud provider infrastructure using the data network; the user equipment receives a communication session establishment accept message, transmitted by the control plane function of the telecommunications network; and the user equipment uses the established communication session to access the further network via a user plane function of the telecommunications network.

### CROSS-REFERENCE TO PRIOR APPLICATIONS

This application is a U.S. National Phase application under 35 U.S.C. § 371 of International Application No. PCT/EP2023/084133, filed on Dec. 4, 2023, and claims benefit to European Patent Application No. EP 23150013.3, filed on Jan. 2, 2023. The International Application was published in English on Jul. 11, 2024 as WO 2024/146722 A1 under PCT Article 21(2).

### FIELD

The present invention relates a method for using a user equipment with a telecommunications network, wherein the user equipment requests, while being connected to the telecommunications network, to be connected to or to access a further network, wherein the telecommunications network comprises a control plane function and a user plane function, wherein the further network is a virtual network as part of a cloud provider infrastructure, and the further network being accessible, from within the cloud provider infrastructure, using a target network identifier information.

Furthermore, the present invention relates to a user equipment for being operated with a telecommunications network, wherein the user equipment is configured to request, while being connected to the telecommunications network, to be connected to or to access a further network, the further network being a virtual network as part of a cloud provider infrastructure and the further network being accessible, from within the cloud provider infrastructure, using a target network identifier information.

Additionally, the present invention relates to a system or telecommunications network for using a user equipment with the telecommunications network, wherein the user equipment requests, while being connected to the telecommunications network, to be connected to or to access a further network, wherein the telecommunications network comprises a control plane function and a user plane function, wherein the further network is a virtual network as part of a cloud provider infrastructure, and the further network being accessible, from within the cloud provider infrastructure, using a target network identifier information.

Furthermore, the present invention relates to a program and to a computer-readable medium for using a user equipment with the telecommunications network according to an embodiment of the inventive method.

### BACKGROUND

In conventional telecommunications networks, in case that a user equipment—especially an application thereof or running on the user equipment—needs to have connectivity to a specific networking resource or resource provider, such connectivity typically requires the establishment or the provisioning of a data network, associated with a data network name (DNN), by the telecommunications network or within the respective core network of or assigned to the telecommunications network. As a consequence thereof, in conventional telecommunications networks, as a prerequisite of the user equipment (or an application thereof) having or getting connectivity to such a specific networking resource or resource provider, the respective (or considered) user equipment (or the application thereof) needs to request connectivity to a data network (or to a data network name, DNN) or to a combination of a data network (name) (DNN) and a network slice (S-NSSAI, single-network slice selection assistance information).

However, such a need (for the user equipment or the application thereof) to necessarily request connectivity to a data network name and/or a network slice typically renders the establishment of the connection or the connectivity to the specific networking resource or resource provider more cumbersome and/or more complicated than necessary.

### SUMMARY

In an exemplary embodiment, the present invention provides a method for using a user equipment with a telecommunications network. The user equipment requests, while being connected to the telecommunications network, to be connected to or to access a further network. The telecommunications network comprises a control plane function and a user plane function. The further network is a virtual network as part of a cloud provider infrastructure. The further network is accessible, from within the cloud provider infrastructure, using a target network identifier information. In order for the user equipment to use or to get access to the further network, a data network and associated data network name is required to be provisioned or established at the telecommunications network or between the telecommunications network and the cloud provider infrastructure. In order for the user equipment to be connected to or to access the further network, the method comprises the following steps: in a first step, the user equipment requests a communication session to be established to or towards the further network, using the target network identifier information as part of a request message being transmitted, by the user equipment, to the control plane function of the telecommunications network; in a second step, the communication session is associated to the data network and/or data network name in order to provide connectivity towards the further network via the cloud provider infrastructure using the data network; in a third step, the user equipment receives a communication session establishment accept message, transmitted by the control plane function of the telecommunications network; and in a fourth step, the user equipment uses the established communication session to access the further network via the user plane function of the telecommunications network.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a telecommunications network comprising an access network, a core network and a user equipment, wherein the core network typically comprises a number of network functions or services, and wherein the telecommunications network is connected to a cloud provider infrastructure comprising a further network being a virtual network as part of the cloud provider infrastructure.

FIG. 2 schematically illustrates an example of a data network connectivity of the user equipment (or of an application thereof) using the telecommunications network, i.e. the access network and the core network, the data network connectivity of the user equipment being realized towards a plurality of data networks or data network names.

FIG. 3 schematically illustrates different connection possibilities or connectivity possibilities of different user equipments.

FIG. 4 schematically illustrates the example of a user equipment being connected to virtual network where the connectivity to the virtual network already exists.

FIG. 5 schematically illustrates a communication diagram between the user equipment, a control plane function of the telecommunications network, a user plane function of the telecommunications network, and the cloud provider infrastructure in case that the connectivity to the virtual network already exists.

FIG. 6 schematically illustrates a communication diagram between the user equipment, a control plane function of the telecommunications network, a user plane function of the telecommunications network, and the cloud provider infrastructure in case that the connectivity to the virtual network does not yet exists, i.e. needs to be established.

### DETAILED DESCRIPTION

Exemplary embodiments of the present invention provide a technically simple, effective and cost effective solution for using a user equipment with a telecommunications network, wherein the user equipment requests, while being connected to the telecommunications network, to be connected to or to access a further network, the further network being accessible from within the cloud provider infrastructure and using a target network identifier information. Further exemplary embodiments of the present invention provide a corresponding user equipment, system or telecommunications network, and a corresponding program and computer-readable medium.

In an exemplary embodiment, the present invention provides a method for using a user equipment with a telecommunications network, wherein the user equipment requests, while being connected to the telecommunications network, to be connected to or to access a further network, wherein the telecommunications network comprises a control plane function and a user plane function, wherein the further network is a virtual network as part of a cloud provider infrastructure,
wherein the further network is accessible, from within the cloud provider infrastructure, using a target network identifier information,
wherein, in order for the user equipment to use or to get access to the further network, a data network and associated data network name is required to be provisioned or established at the telecommunications network or between the telecommunications network and the cloud provider infrastructure,
wherein, in order for the user equipment to be connected to or to access the further network, the method comprises the following steps:
   in a first step, the user equipment requests a communication session to be established to or towards the further network, using the target network identifier information as part of a request message being transmitted, by the user equipment, to the control plane function of the telecommunications network,
   in a second step, the communication session is associated to the data network and/or data network name in order to provide connectivity towards the further network via the cloud provider infrastructure using the data network or the data network name,
   in a third step, the user equipment receives a communication session establishment accept message, transmitted by the control plane function of the telecommunications network,
   in a fourth step, the user equipment uses the established communication session to access the further network via the user plane function of the telecommunications network.

According to the present invention, it is advantageously possible that, in a telecommunications network (typically, but not necessarily, a mobile communication network), a user equipment is enabled to request connectivity to a specific networking resource or resource provider (i.e. to a further network that is accessible from within a cloud provider infrastructure) using a target network identifier information as opposed to the paradigm, in conventional telecommunications networks, of necessarily requesting connectivity to a combination of data network name (DNN) and/or a network slice.

In conventional telecommunications networks, in order for a user equipment to realize connectivity to a network within a cloud provider, this can only be done via a VPN—virtual private network. While the network operator (of the telecommunications network to which the user equipment is connected) can provide connectivity to a data network (DN), anything beyond that needs to happen over the top (OTT), i.e. typically the user equipment needs previous knowledge of certain parameters in order to achieve connectivity to the intended network. Such requirements of previous knowledge by (or at) the user equipment conflicts with an impulse to rather simplify the user equipments, as well as to allow user equipments to natively access third-party networks and allow the operator to abstract underlying network complexity.

In conventional telecommunications networks—typically being based on a separation between the user equipment, the (radio) access network and the core network—, in order to provide a user equipment with connectivity towards a data network (DN)—e.g., the internet—, the user equipment communicates with the access network (especially the radio access network in a mobile communication network, via a radio interface) and with the core network, and the data network provides connectivity towards applications (e.g. a backend for an application running on the user equipment) via a packet data unit session (PDU session) being established between the user equipment and the data network. In this sense, a conventional telecommunications network, e.g. a 5G system, provides a “pipe” (i.e. the packet data unit session) realizing connectivity to a given data network. Said connectivity is then typically exposed to application(s) in the user equipment by the operating system via a network interface, with the user equipment being addressable within the data network via, e.g., an IP address, e.g. IP address 10.10.10.42 assigned to the user equipment on PDU Session 1 and another IP address 192.168.0.23 assigned to the user equipment via (or on) PDU Session 2.

Within the context of cloudification and the use of public/hybrid clouds, it is common to use virtual networks, i.e. further networks, being separated from the telecommunications network to which the user equipment is connected to. While different names may be used by different cloud providers (e.g. Virtual Network, “Vnet”; Virtual Private Cloud, “VPC”), a virtual network within a cloud is a virtual version of a physical network, implemented inside of a cloud provider's production network (i.e. inside a cloud provider infrastructure); typically, a virtual network can subsequently be further segmented in several subnetworks. A virtual network provides network connectivity and address allocation to elements (e.g. cloud resources such as virtual machines) within the virtual network. Such virtual networks are typically constructs within a (public) cloud, i.e. a cloud provider infrastructure, and typically use private ranges or IP addresses (e.g. within a Class A address range, for example 10.0.0.0/8); being private networks, devices outside of a considered cloud (or cloud provider infrastructure) can only be part of such virtual network if connectivity is provided within the network or cloud provider infrastructure, typically via a VPN gateway accessible via the public Internet. Virtual networks—as typically all cloud resources—are typically identified by a unique identifier, virtual network identifier, most commonly a universally unique identifier (UUID) such as, e.g., “00112233-4455-6677-c899-aabbccddeeff”.

Hence, a virtual network is a private network placed within a cloud provider or cloud provider infrastructure, where cloud resources (e.g. virtual machines, Kubernetes (k8s) clusters, software as a service (Saas) offerings, etc.) can be instantiated/addressed. However, such resources within a virtual network—as well as the virtual network itself—cannot be accessed from the “outside” (i.e. Internet) unless a given resource is allocated a public IP address (in this case the given resource can be addressed via the Internet) or via VPN tunnel, via which the virtual network can be connected to other networks at the other side of the VPN tunnel via routing mechanisms.

According to the present invention, it is advantageously possible for a user equipment to easily realize connectivity to a cloud-based network (further network) which connectivity establishment requires previous knowledge of certain parameters so that the user equipment can achieve this connectivity to the intended network: The method advantageously reduces the complexity of realizing such a connectivity for the considered user equipment: The user equipment only needs to know the further network (i.e. the respective target network identifier information thereof) it wants to connect to, indicate it to the network, and the rest is taken care of by the telecommunications network.

Especially according to the present invention, the user equipment (or the application triggering the user equipment) triggers a communication session establishment (especially a packet data unit session establishment) targeting the further network that is not directly accessible (via the telecommunications network the user equipment is attached to). The user equipment is only required to know what the target network identifier information, i.e. the virtual network, (where connectivity is required to) is—not how to achieve it. According to the present invention, this is achieved by the user equipment including a virtual network identifier, i.e. the target network identifier information, in the communication session establishment request, typically a PDU session establishment request. Based on the subscriber data (e.g. whether the user equipment is allowed to get said connectivity, what quality-of-service level is to apply or is the user equipment allowed to, via what network slice should the connectivity be realized), the telecommunications network (to which the user equipment is connected to) either associates the communication session (or PDU session) to an existing data network name (DNN) and/or network slice (S-NSSAI) via which this information can be routed towards the further network within the cloud provider infrastructure, or the telecommunications network provisions connectivity to the respective further network. The user equipment then gets a communication session accept message (typically a PDU Session establishment accept message) and can transmit and/or receive data as normally done via communication sessions (or PDU Sessions) with the exception that in this case the connectivity (request of the user equipment initially) is typically not (or not necessarily) towards a DNN or combination of DNN/S-NSSAI but rather towards the further network being a virtual network.

According to the present invention, it is assumed that the user equipment is used with the telecommunications network, i.e. it is connected to the user equipment, and, while being connected to the telecommunications network, the user equipment requests to be connected to or to access the further network being a virtual network as part of a cloud provider infrastructure. The telecommunications network comprises a control plane function and a user plane function, and the further network is accessible from within (especially only from within, i.e. not from outside of) the cloud provider infrastructure, using a target network identifier information of the further network.

It is furthermore assumed that, in order for the user equipment to use or to get access to the further network, a data network and associated data network name is required to be provisioned or established at the telecommunications network or between the telecommunications network and the cloud provider infrastructure. That is, the cloud provider infrastructure is reached from the telecommunications network via a data network. In the context of the present invention, the terms data network and data network name are used rather synonymously, especially the data network relating to an identifier information to indicate, or reference,—especially for the purposes of the telecommunications network or of its core network—the associated data network. In order for the user equipment to be actually connected to or to access the further network, the user equipment requests (in a first step of an embodiment of the inventive method) a communication session to be established to or towards the further network, using the target network identifier information as part of a request message being transmitted, by the user equipment, to the control plane function of the telecommunications network; the communication session is associated (in a second step of an embodiment of the inventive method) to the data network name in order to provide connectivity towards the further network via the cloud provider infrastructure using the data network name; furthermore the user equipment receives (in a third step of an embodiment of the inventive method) a communication session establishment accept message, transmitted by the control plane function of the telecommunications network; and, the user equipment uses (in a fourth step of an embodiment of the inventive method) the established communication session to access the further network via the user plane function of the telecommunications network. Especially, the communication session establishment request of the user equipment (in a first step of an embodiment of the inventive method) does not necessarily comprise a reference, or an indication, to a data network name (instance) to be used. Furthermore, when the user equipment requests the communication session to be established to or towards the further network, the data network name may not have been vet provisioned or established.

According to the present invention, it is furthermore advantageously possible and preferred that the further network is accessible, using the target network identifier information, only from within the cloud provider infrastructure,
wherein especially the further network is not directly accessible from the outside of the cloud provider infrastructure.

It is thereby advantageously possible to realize and implement embodiments of the inventive method in a comparatively simple and efficient manner: Even though the further network is not (directly) accessible from the telecommunications network (only via using the target network identifier information), it is nevertheless advantageously possible, according to the present invention, that the user equipment is able to get connectivity to the further network.

According to the present invention, it is furthermore advantageously possible and preferred that the communication session is or corresponds to a protocol data unit, PDU, session, and/or wherein the control plane function is or corresponds to the session management function or a session management function instance.

It is thereby advantageously possible to realize and implement embodiments of the inventive method in a comparatively simple and efficient manner.

Furthermore, it is advantageously possible and preferred according to the present invention that—after provisioning or establishing the data network name—the data network name and the further network as well as its target network identifier information are assigned to each other,
wherein especially such assigning is stored in a repository entity or functionality of the telecommunications network,
wherein especially such assigning is performed
   prior to the first step, or
   subsequent to the first step, especially subsequent to the third step.

It is thereby advantageously possible to efficiently realize and implement embodiments of the inventive method in a comparatively simple and flexible manner as the assignment of the data network name and the further network as well as its target network identifier information is possible to be performed at different points in time.

Furthermore, it is advantageously possible and preferred according to the present invention that the data network name and the further network and its target network identifier information are assigned to each other, wherein such assigning as well as the provisioning or establishing of the data network name is performed subsequent to the first step, especially subsequent to the third step.

Furthermore, it is advantageously possible and preferred according to the present invention that the data network name associated to the further network provides a different, especially higher, quality of service compared to connectivity via the Internet, such that connectivity towards the further network can be achieved with higher reliability and/or quality compared to over-the-top methods.

Furthermore, it is advantageously possible and preferred according to the present invention that for a given further network, when different user equipments request a communication session to be established to or towards the further network, different data networks providing connectivity towards the further network can be employed for different user equipments, especially where the choice of data network and/or associated quality is based on subscriber or policy information related to one or more user equipments.

It is additionally advantageously possible and preferred according to the present invention that if the data network name is not in use or required anymore, e.g. when all user equipments requiring connectivity to the further network deregistered from the network, that the data network instance is un-provisioned, such that resource usage and/or costs, especially the instantiated resources, reserved capacity and/or connectivity required on the side of the cloud provider infrastructure, can be optimized.

It is thereby advantageously possible to realize and implement embodiments of the inventive method in a comparatively simple and efficient manner.

Furthermore, it is advantageously possible and preferred according to the present invention that the cloud provider infrastructure comprises a cloud controller entity or functionality and/or a cloud ingress router entity or functionality, wherein provisioning or establishing the data network name and/or assigning or associating the data network name, the further network and its target network identifier information involves contacting, by the telecommunications network, the cloud controller entity or functionality and/or the cloud ingress router entity or functionality, and wherein the cloud ingress router entity is accessible from the telecommunications network via the data network name and forwards data packets between the further network and the telecommunications network.

It is thereby advantageously possible to realize and implement embodiments of the inventive method in a comparatively simple and efficient manner.

Furthermore, it is advantageously possible and preferred according to the present invention that the target network identifier information is or corresponds to or comprises a universally unique identifier, UUID, information of the further network.
wherein especially the target network identifier information comprises an infrastructure identifier information relating to the cloud provider infrastructure, or identifying the cloud provider infrastructure.

It is thereby advantageously possible to realize and implement embodiments of the inventive method in a comparatively simple and efficient manner.

Furthermore, the present invention relates to a user equipment for being operated with a telecommunications network, wherein the user equipment is configured to request, while being connected to the telecommunications network, to be connected to or to access a further network, the further network being a virtual network as part of a cloud provider infrastructure and the further network being accessible, from within the cloud provider infrastructure, using a target network identifier information,
wherein, in order for the user equipment to use or to get access to the further network, a data network and associated data network name is required to be provisioned or established at the telecommunications network or between the telecommunications network and the cloud provider infrastructure,
wherein, in order for the user equipment to be connected to or to access the further network, the user equipment is configured such that:
   the user equipment requests a communication session to be established to or towards the further network, using the target network identifier information as part of a request message being transmitted, by the user equipment, to the control plane function of the telecommunications network,
   the user equipment receives a communication session establishment accept message, transmitted by the control plane function of the telecommunications network,
   the user equipment uses the established communication session to access the further network via the user plane function of the telecommunications network after the communication session is associated to the data network name in order to provide connectivity towards the further network via the cloud provider infrastructure using the data network name.

Furthermore, the present invention relates to a system or telecommunications network for using a user equipment with the telecommunications network, wherein the user equipment requests, while being connected to the telecommunications network, to be connected to or to access a further network, wherein the telecommunications network comprises a control plane function and a user plane function, wherein the further network is a virtual network as part of a cloud provider infrastructure,
wherein the further network is accessible, from within the cloud provider infrastructure, using a target network identifier information,
wherein, in order for the user equipment to use or to get access to the further network, a data network and associated data network name is required to be provisioned or established at the telecommunications network or between the telecommunications network and the cloud provider infrastructure.
wherein, in order for the user equipment to be connected to or to access the further network, the system or telecommunications network is configured such that:
   the telecommunications network receives, from the user equipment, a request message regarding a communication session to be established to or towards the further network, the target network identifier information being part of the request message received by the control plane function of the telecommunications network,
   the communication session is associated to the data network and/or data network name in order to provide connectivity towards the further network via the cloud provider infrastructure using the data network name,
   the control plane function of the telecommunications network transmits, and the user equipment receives, a communication session establishment accept message,
   the established communication session is used, by the user equipment, to access the further network via the user plane function of the telecommunications network.

Additionally, the present invention relates to a program comprising a computer readable program code which, when executed on a computer and/or on a user equipment and/or on a network node of a telecommunications network, especially a control plane function, or in part on the user equipment and/or in part on the network node of a telecommunications network, especially the control plane function, causes the computer and/or the user equipment and/or the network node of the telecommunications network to perform an embodiment of the inventive method.

Additionally, the present invention relates to a computer-readable medium comprising instructions which when executed on a computer and/or on a user equipment and/or on a network node of a telecommunications network, especially a control plane function, or in part on the user equipment and/or in part on the network node of a telecommunications network, especially the control plane function, causes the computer and/or the user equipment and/or the network node of the telecommunications network to perform an embodiment of the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

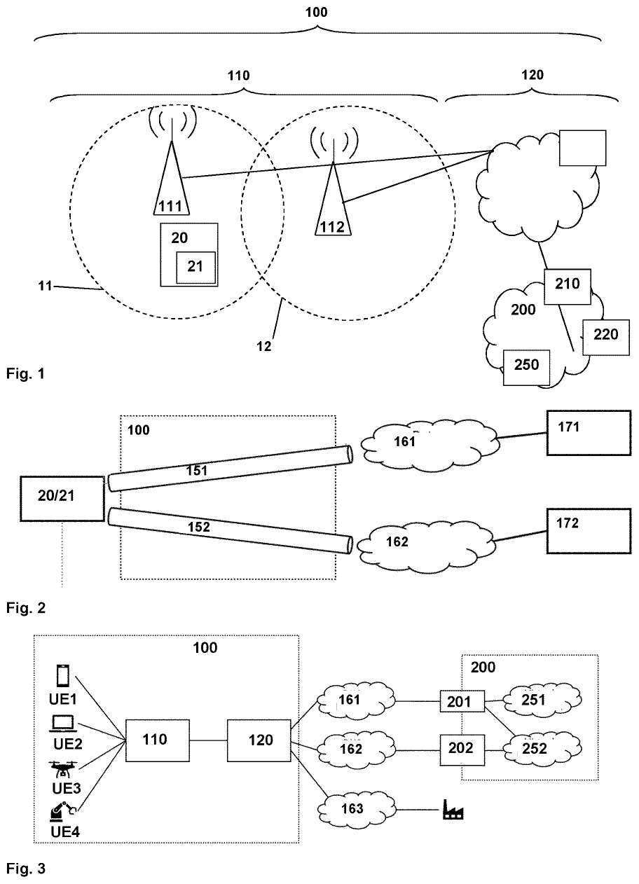

In FIG. 1, a telecommunications network 100 comprising an access network 110, and a core network 120 is schematically shown. The telecommunications network 100, especially the core network 120, typically comprises a number of network functions or services. The access network 110 comprises a plurality of radio cells 11, 12. In the exemplary situation or scenario shown in FIG. 1, a first base station entity 111 generates or is associated with or spans the first radio cell 11, and a second base station entity 112 generates or is associated with or spans the second radio cell 12. In the exemplary situation shown in FIG. 1, the user equipment 20 is connected to the telecommunications network 100 via a radio interface to the first base station entity 111. The user equipment 20 is typically, but not necessarily, mobile i.e. able to move with respect to the (typically, but not necessarily, static) radio cells 11, 12 or corresponding base station entities 111, 112 of the access network 110. According to the present invention, the user equipment 20 typically comprises an application 21 (schematically depicted, in FIG. 1, as part of the user equipment 20) typically running on the user equipment 20, i.e. the user equipment 20 typically runs or executes an operating system (such as a mobile (devices) operating system, e.g., android, iOS, iPadOS, etc.), and the application 21 is running on the operating system: alternatively, the application 21 might also be a lower level application not running on or as part of the operating system but as part of, e.g., the subscriber identity module of the user equipment 20.

According to the present invention, the telecommunications network 100 is connected to a cloud provider infrastructure 200 comprising a further network 250 being a virtual network as part of the cloud provider infrastructure 200. Furthermore, the cloud provider infrastructure 200 is represented, in FIG. 1, as also comprising a cloud controller entity or functionality 210 and a cloud ingress router entity or functionality 220.

In FIG. 2, an example of a data network connectivity of the user equipment 20 (or of its application 21) is schematically shown, wherein the user equipment 20 (the application 21) uses the telecommunications network 100—i.e. the access network and the core network, especially realized as a 5G system—to be provided, e.g., with services 171, 172, the data network connectivity of the user equipment 20 (the application 21) being realized towards a plurality of data networks or data network names 161, 162 using communication sessions, 151, 152, especially packet data unit sessions 151. 152. Such a data network connectivity of user equipments is already possible to be realized in conventional telecommunications networks; e.g. the connectivity to the data networks 161, 162 is exposed to the user equipment 20 and/or its application 21 as network interfaces, for example with the user equipment 20 being addressable, within the data networks 161, 162, via, e.g., an IP address, respectively (e.g. IP address 10.10.10.42 assigned to the user equipment 20 (or application 21) on the first packet data unit session 151 and usable by the first data network 161, and another IP address 192.168.0.23 assigned to the user equipment 20 (or application 21) on the second packet data unit session 152 and usable by the second data network 162). Likewise, the connectivity to the user equipment 20 (or to the application 21) is also exposed, to the first and/or second data networks 161, 162 via network addresses, e.g. IP addresses. Hence, a first service 171 is able to be provided, to the user equipment 20 or the application 21 via (or using) the first data network 161 and the first packet data unit session 151, and a second service 172 is able to be provided, to the user equipment 20 or the application 21 via (or using) the second data network 162 and the second packet data unit session 152.

According to the present invention, the telecommunications network 100 is organized or structured—in accordance to current or conventional mobile networks—based on a separation between the user equipment 20, the (radio) access network 110 and the core network, which applies, e.g., to 5G systems (5GS), i.e. telecommunications networks according to the 5G standard.

The objective is to provide the user equipment 20 with connectivity towards a data network (DN), e.g., the Internet (e.g. such as the data networks 161, 162 shown in FIG. 2). In case of the telecommunications network 100 being a mobile communication network (or a cellular network), the user equipment 20 communicates with the radio access network 110 (or its base station entity 111, especially a gNodeB) via a radio interface (Uu interface or reference point), which is used for conveying both signaling information and data traffic. The data network 161, 162 provides connectivity towards services or backend applications 171, 172 (e.g. a backend for an application 21 running on the user equipment 20). Additionally, (network) slicing allows the telecommunications network 100 to be segmented into logical sections (i.e. “slices”) which can be accessed by user equipments 20 and be used to offer differentiated services.

Furthermore, both according to the present invention as in conventional networks. such systems typically separate a control plane from a user plane (i.e., signaling traffic and (user) data traffic are separated); the traffic between the user equipment 20 and the telecommunications network 100 is transmitted via the communication sessions 151, 152, especially packet data unit sessions 151, 152, which are anchored at a PDU session Anchor (PSA), especially the user plane function (UPF) in the case of the telecommunications network 100 being a 5G network (especially using the N3 interface or reference point between the gNB and the UPF). Similarly, an access and mobility management function (AMF) acts as a signaling anchor (so-called N1/N2 interface) for control plane traffic.

In order for the user equipment 20 being able to have connectivity towards the services 171, 172, the data network 161, 162—or, a corresponding data network name—is required to be established as well as a corresponding communication session, especially a packet data unit session 151, 152 needs to be established.

Especially in case of a conventional 5G system, such packet data unit session establishment procedure (according to 3GPP TS 23.502, clause 4.3.2.2.1.) comprises, in a first part the following procedures: The procedure assumes that the user equipment has already registered on the AMF thus (unless the user equipment is emergency registered) the AMF has already retrieved the user subscription data from the unified data management (UDM); the user equipment transmits (to the access and mobility management function) a non-access stratum message comprising:
the corresponding (requested) S-NSSAI(s),
the user equipment requested data network name DNN,
the PDU Session ID,
a request type information,
an old PDU Session ID.
an N1 SM (session management) container (comprising the PDU session establishment request, and perhaps a port management information container).

In order to establish a new PDU session, the user equipment generates a new PDU session ID, and the user equipment initiates the user equipment requested PDU session establishment procedure by the transmission of a NAS message containing a PDU session establishment request within the N1 SM container.

Hence, in conventional telecommunications networks and as already mentioned, in order to provide a user equipment with connectivity towards a data network, the user equipment communicates with the access network and with the core network, and the data network provides connectivity towards services via a packet data unit session (PDU session), i.e. the telecommunications network, e.g. a 5G system, provides the packet data unit session as a ‘pipe’ realizing connectivity to a given data network.

In case the further network (or the service connected via the packet data unit session) is part of a cloud provider infrastructure such resources within a virtual network, or the virtual network itself are typically not accessible by the user equipment and via the packet data unit session and the data network without prior or previous knowledge and/or prior configuration steps: this is explained in the following:
In a typical setup of a cloud-based virtual network, such a virtual network, e.g., comprises a plurality of virtual machines, a software as a service database and/or a Kubernetes cluster (k8s cluster). The associated or corresponding cloud provider infrastructure, e.g., comprises a load balancer having (or being related to) a public IP address (connected to the internet) via which IP address an internet user can access the load balancer (i.e. the cloud provider infrastructure) via its public IP address but the user could not access the virtual network itself. Furthermore, the cloud provider infrastructure, e.g., comprises a VPN gateway towards a corporate network (that also comprises a VPN gateway terminating the VPN tunnel on its other side); a corporate user is able to route traffic between the virtual network and the corporate network via the VPN tunnel. However, such connectivity to the virtual network is only possible as the VPN tunnel is (already) established; a virtual network or resources within a virtual network cannot be accessed directly from the “outside” (i.e. the internet) unless a given resource is allocated a public IP address (in this case the given resource can be addressed via the internet) or via the VPN tunnel (via which the virtual network can be connected to other networks at the other side of the VPN tunnel via routing mechanisms); furthermore, similar methods exist to connect different virtual networks within a cloud provider or cloud provider infrastructure.

Alternatively or cumulatively in terms of connectivity, it is also possible to implement connectivity towards a cloud or towards a virtual network via private connectivity: this is a preferred option when stringent performance requirements apply or when it is not desired that the traffic, even if in encrypted form, runs through the internet.

Hence, it is possible to connect to a virtual network via a VPN via the Internet, via dedicated connectivity and also using both methods simultaneously (e.g. for redundancy and/or cost-effective load balancing); an alternative in-between these two solutions would be reaching the cloud provider or virtual network not via the Internet but rather via a private peering point such that the VPN endpoints can be achieved more reliably as via the Internet.

In this respect, FIG. 3 schematically and exemplarily shows different connection possibilities or connectivity possibilities of (exemplary) different user equipments UE1, UE2, UE3, UE4 (being part of or connected to the telecommunications network 100), and being potentially linked to (or provided connectivity towards) a first virtual network 251 or a second virtual network 252 of a cloud provider infrastructure 200 via either a VPN endpoint 201 of the cloud provider infrastructure 200 or a direct connection endpoint 202 of the cloud provider infrastructure 200:

In conventional telecommunications networks. a user equipments UE1, UE2, UE3, UE4 (e.g. mobile devices but this is also applicable to a fixed-network device connecting via a 3GPP-based system) can request (and be provided with) connectivity via a PDU session establishment (request) to a given DNN 161, 162, 163 through a given slice (S-NSSAI/DNN pair). E.g., UE1 might require connectivity to the first virtual network 251; UE2 might require access to the second virtual network 252; UE3 might require low latency and access to the second virtual network 252; and UE4 might require low latency and access to the enterprise network (local network) of the enterprise, as well as the first virtual network 251. In order to realize such a connectivity scenario, the network is able to be configured such that: the first data network name 161 is configured to provide access to the Internet; the second data network name 162 is configured to provide direct access to the second virtual network 252; the third data network name 163 is configured to provide connectivity to the local network; A default (network) slice providing connectivity to the first and second data network name 161, 162 is enabled for UE1 and UE2; additionally a prioritized (network) slice (e.g. reserved RAN resources), providing connectivity to the first, second and third data network name 161, 162, 163, is enabled for UE3 and UE4; each one of the UEs is configured to request appropriate PDU session(s) for a Slice/DNN pair providing access to the correct data network name (i.e. corresponding to the above mentioned exemplary scenario). For the case of the first data network name 161, the application (on the respective user equipment) will then have to additionally start a VPN client on top of the PDU Session with appropriate (re-)configuration so that the connection with the cloud provider's virtual network 251, 252 can be established. Hence, such a connectivity scenario is possible to realize in a conventional telecommunications network, however keeping track of all those (potentially changing) configurations might be rather complex.

As already said, according to the present invention, it is advantageously possible that a user equipment is enabled to request connectivity to a specific networking resource or resource provider (i.e. to a further network that is accessible from within a cloud provider infrastructure) using a target network identifier information as opposed to the paradigm, in conventional telecommunications networks, of necessarily requesting connectivity to a combination of data network name (DNN) and/or a network slice.

Hence, also according to the present invention, the user equipment 20 is connected to the telecommunications network 100, and, while being connected, requests to be connected to or to access the further network 250—i.e. the virtual network being part of the cloud provider infrastructure 200 and being accessible, from within the cloud provider infrastructure 200, using its target network identifier information 251. Hereinafter, the further network 250 is also called virtual network 250. Also according to the present invention, it is assumed that, in order for the user equipment 20 to use or to get access to the further network 250, a data network and associated data network name is required to be provisioned or established at the telecommunications network 100 or between the telecommunications network 100 and the cloud provider infrastructure 200, however, such data network name does not necessarily need to be instantiated (or exist) prior to or at the time of the connectivity request of the user equipment 20. According to the present invention, the steps required for the user equipment 20 to be provided with connectivity towards the further network 250 comprise
the user equipment 20 requesting a communication session to be established to or towards the further network 250, using the target network identifier information 251 as part of a request message being transmitted, by the user equipment 20, to the control plane function 130 of the telecommunications network 100,
the communication session being associated to the data network name in order to provide connectivity towards the further network 250 via the cloud provider infrastructure 200 using the data network name.
the user equipment 20 receiving a communication session establishment accept message, transmitted by the control plane function 130 of the telecommunications network 100, and
the user equipment 20 using the established communication session to access the further network 250 via the user plane function 140 of the telecommunications network 100.

Hence, there is-according to the present invention-not necessarily a need for the user equipment 20 to transmit a data network (name) identifier or corresponding information as part of its request to establish the communication session via which the user equipment 20 can subsequently establish a communication with the cloud provider infrastructure 200, neither for the user equipment 20 to store addressing information of control and/or user plane elements of the cloud provider infrastructure 200. Thus, the complexity for providing the user equipment 20 with connectivity to the further network 250 or for providing access to the further network 250 is able to be reduced according to the present invention: the user equipment 20 only needs to know the network it wants to connect to (i.e. the target network identifier information), indicate it to the telecommunications network 100, and the rest is taken care of. That is, there is no need for the user equipment 20 to be aware of any information related to an underlying data network (name), an underlying slice (identifier) and/or any other parameter such as quality of service that are used to provide connectivity between the telecommunications network 100 and the cloud provider infrastructure 200 so as to reach the further network 250. Thus, the user equipment 20 (or the application 21 (running or being executed on the user equipment 20) triggering the user equipment 20) triggers a communication session establishment (especially a packet data unit session establishment) targeting the further network 250) that is not directly accessible (via the telecommunications network 100 the user equipment 20 is attached to); the user equipment 20 is only required to know the target network identifier information, i.e. the virtual network where connectivity is required to—not how to achieve such connectivity. According to the present invention, this is achieved by the user equipment 20 including a virtual network identifier, i.e. the target network identifier information 251, in the communication session establishment request, typically a PDU session establishment request. Based on the subscriber and/or policy data relating to the user equipment 20 (e.g. whether the user equipment 20 is allowed to get said connectivity, what quality-of-service level is to be applied or is the user equipment 20 allowed to, via what network slice should the connectivity be realized), the telecommunications network 100 (to which the user equipment 20 is connected to) either associates the communication session (or PDU session) to an existing data network name (DNN) and/or network slice (S-NSSAI) via which this information can be routed, or the telecommunications network provisions connectivity to the respective further network. The user equipment 20 then gets a communication session accept message and can transmit and/or receive data as normally done via communication (PDU) sessions with the exception that in this case the connectivity is typically not (or not necessarily) requested towards a DNN/S-NSSAI but rather towards the further network 250 being a virtual network. According to first variants of the present invention, the connectivity (of the core network 120, or parts thereof) to the virtual network 250 already exists (at the time of the connection request of the user equipment 20), wherein according to second variants of the present invention, the connectivity to the virtual network 250 does not yet exists, i.e. needs to be established (at the time of the connection request of the user equipment 20).

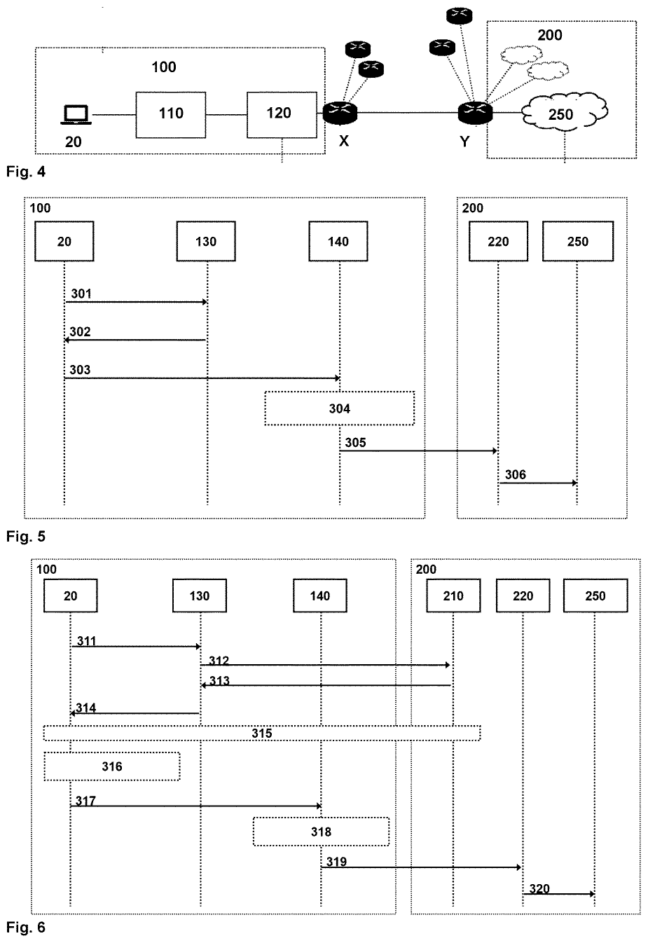

FIGS. 4 and 5 relate to the first variants of the present invention. In FIG. 4, the example of the user equipment 20 being connected (via the access network 110 and core network 120 of the telecommunications network 100) to the virtual network 250 (as part of the cloud provider infrastructure 200) is schematically shown where the connectivity (of the core network 120, or parts thereof) to the virtual network 250 already exists: The user equipment 20 requests the communication session establishment via a request message comprising (especially instead of a DNN/S-NSSAI information) the target network identifier information 251 of the virtual network 250 in order to get connectivity to the further network 250. Especially, the requested target network identifier information 251 of the virtual network 250) is (already) mapped, by the core network 120, to a data network (name) (and/or to a S-NSSAI) that are configured to provide access to the specific requested (pre-configured) virtual network 250; e.g. traffic from the user equipment 20 is directed to classless inter-domain routing (CIDR) 10.0.0.0/8. The corresponding data network is e.g. connected via interface X, and the virtual network router interface via interface Y. Routing tables are typically configured, e.g. via border gateway protocol (BGP), to route traffic to 10.0.0.0/8 via interface Y. On the side of the cloud provider infrastructure 200, incoming traffic (at interface Y) is routed based on configured routing tables (incoming interface, destination CIDR) to a virtual network within the cloud provider infrastructure 200 (other virtual networks might use the same (or overlapping) CIDR(s) but such virtual network would use other interfaces.

Hence, in case that the connectivity of the telecommunications network 100 to the virtual network 250 already exists, when receiving (from the user equipment 20) a request including a virtual network identifier (or target network identifier information 251), the core network 120 maps the target user plane connectivity to a given existing connectivity, that is, a data network (name). That is, using the virtual network identifier (target network identifier information 251) (as part of the connectivity request transmitted by the user equipment 20) also results—just as the user equipment 20 (and any other user equipment requiring connectivity to the further network 250) having been configured to map a connectivity request towards the further network 250 to a request to a given DNN or DNN/S-NSSAI pair—in the user equipment 20 being connected (or getting connectivity) to the further network 250 without the specific mapping needing to be configured and maintained on a user equipment 20 requiring connectivity to the further network 250. Whether a specific user plane function (UPF)/session management function (SMF) is used (e.g. reserved for a given slice ID. S-NSSAI) can also be taken care of by the core network 120, i.e. the user equipment 20 can be assigned a higher-QoS network function based on a mapping configured in the core network 120 and/or based on subscription information related to the user equipment 20 or credentials user by the user equipment 20.

In the example of FIG. 4. the virtual network 250 (or further network 250) uses a CIDR of 10.0.0.0/8, which is routable by the router on the core network 120 and cloud provider side towards the configured virtual network 250. While other virtual networks (as part of the cloud provider infrastructure 200) may (and most probably do) use exactly the same CIDR, the combination of input interface (i.e. interfaces X and/or Y) and CIDR is unique, hence the traffic can be routed by a specific link (e.g. realized via a VLAN) between the telecommunications network 100 on the one hand, and the cloud provider infrastructure 200 on the other hand. The cloud provider (i.e. the cloud provider infrastructure 200)) routes traffic towards the correct virtual network 250 in a similar manner.

In FIG. 5, a communication diagram, especially regarding the flow of user plane data, between the user equipment 20, a control plane function 130 of the telecommunications network 100 (or of its core network 120), a user plane function 140 of the telecommunications network 100 (or of its core network 120), and the cloud provider infrastructure 200 is schematically shown in case that the connectivity to the virtual network 250) already exists. E.g. the connectivity of the core network 120, or of parts thereof, to the virtual network 250 already exists due to a pre-configured routed connection where traffic from a given router interface can be directly routed to an IP range within the virtual network 250)—then the core network 120 does not need to establish a new connectivity towards the virtual network 250.

In a first processing step 301, the user equipment requests a PDU Session to the further network 250 (or the virtual network 250). In a second processing step 302, a PDU session establishment accept message is transmitted to the user equipment 20, especially comprising security parameters. In a third processing step 303, a data packet is sent via user plane towards the endpoint in the virtual network 250 which means that such a data packet is transported, within the telecommunications network 100, to the user plane function 140. In a fourth processing step 304, the user plane function 140 forwards the data packet to the cloud ingress router entity or functionality 220 of the cloud provider infrastructure 200. In a fifth processing step 305, the data packet is sent via user plane to the cloud ingress router entity or functionality 220, and in a sixth processing step 306, the data packet is sent to the virtual network 250.

In FIG. 6, a communication diagram, especially regarding the flow of user plane data, between the user equipment 20, a control plane function 130 of the telecommunications network 100 (or of its core network 120), a user plane function 140 of the telecommunications network 100 (or of its core network 120), and the cloud provider infrastructure 200 is schematically shown in case that the connectivity to the virtual network 250) does not yet exists, i.e. needs to be established. The provision of connectivity to the virtual network 250 can be accomplished also assuring that end-to-end (E2E) security can be achieved. It may not be desired by the subscriber that the information exchanged between the user equipment 20 and the virtual network 250 is visible and/or modifiable and hence encryption and/or data protection may be desirable.

For this depiction, it is advantageous to separate the network functions into control plane (signaling) functionality and user plane (data traffic) functionality. In a first processing step 311, the PDU session establishment request (transmitted by the user equipment 20) is received by the control plane function 130 of the core network 120. In a 5G network that would be the SM (session management) NAS (non-access stratum) container sent by the user equipment 20 via the access and mobility management function (AMF), transparently forwarded by the access network 110 towards the access and mobility management function via the NG-AP interface. This message triggers a request (cf. the second processing step 312 in FIG. 6) for connectivity to virtual network 250 towards the cloud provider's control plane (cloud controller entity or functionality 210), hereinafter also named “cloud controller”. The following information is considered to be in the request for connectivity: the virtual network identifier (i.e. the target network identifier information 251), the endpoint address of the user plane function (in a 5G network, that would be a user plane function) towards which the cloud provider can send user plane (data packets); information regarding the user equipment 20 that requested the connectivity. In a third processing step 313, the cloud controller 210 sends back: an endpoint towards which the user plane function can send traffic to; additional security parameters the user equipment 20 can use to setup data protection for the data being sent via the network towards the virtual network 250, e.g. encryption, integrity protection. In a fourth processing step 314, the user equipment 20 receives the PDU session accept message and any additional parameters. In a fifth processing step 315, security negotiation can be established between the user equipment 20 and the cloud controller 210; existing technology can be re-used for this. In a sixth processing step 316, the user equipment 20 can then protect a data packet as per any negotiated parameters, e.g. encrypt the data packet so that its content is not visible to the telecommunications network 100, add checksums/signatures so that it cannot be modified. In a seventh processing step 317, the data packet is sent via user plane towards endpoint in the virtual network 250, i.e. to the user plane function 140. In an eighth processing step 318 and a ninth processing step 319, the user plane function 140 forwards the packet to the ingress router 220 of the cloud provider infrastructure 200 as per the endpoints negotiated in the second and third processing steps 312, 313. The packet is then received by the ingress router 220, which then forwards the data packet—in a tenth processing step 320—towards the remote endpoint in the virtual network 250.

According to the present invention. In order to help the telecommunications network 100 to map the target network identifier information 251 (or virtual network identifier) to a given cloud provider (i.e. cloud provider infrastructure 200), it is especially preferred to structure the virtual network identifier to also contain a provider identifier, which the network can then map to a given cloud provider/cloud controller. The structure of the target network identifier information 251 (or Vnet Identifier) then also comprises an indication to the cloud provider. While a virtual network within a cloud provider (or cloud provider infrastructure 200) is typically (uniquely, hence—in principle—sufficiently) identified with a universally unique identifier (UUID), it may also be advantageous to allow the user equipment 20 to further indicate to what provider the UUID (i.e. the target network identifier information 251) belongs to. That can be accomplished by either letting the user equipment 20 indicate a cloud provider identifier (e.g. a string, identifier or UUID) or using a virtual network identifier (target network identifier information 251) containing a cloud provider identifier; examples of such realizations include, e.g.: provider-name-00112233-4455-6677-c899-aabbccddeeff (string-based): 0001-00112233-4455-6677-c899-aabbccddeeff (identifier-based).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for using a user equipment with a telecommunications network, wherein the user equipment requests, while being connected to the telecommunications network, to be connected to or to access a further network, wherein the telecommunications network comprises a control plane function and a user plane function, wherein the further network is a virtual network as part of a cloud provider infrastructure,
wherein the further network is accessible, from within the cloud provider infrastructure, using a target network identifier information,
wherein, in order for the user equipment to use or to get access to the further network, a data network and associated data network name is required to be provisioned or established at the telecommunications network or between the telecommunications network and the cloud provider infrastructure,
wherein, in order for the user equipment to be connected to or to access the further network, the method comprises the following steps:
in a first step, the user equipment requests a communication session to be established to or towards the further network, using the target network identifier information as part of a request message being transmitted, by the user equipment, to the control plane function of the telecommunications network;
in a second step, the communication session is associated to the data network and/or data network name in order to provide connectivity towards the further network via the cloud provider infrastructure using the data network;
in a third step, the user equipment receives a communication session establishment accept message, transmitted by the control plane function of the telecommunications network; and
in a fourth step, the user equipment uses the established communication session to access the further network via the user plane function of the telecommunications network.

2. The method according to claim 1, wherein the further network is accessible, using the target network identifier information, only from within the cloud provider infrastructure;
wherein especially the further network is not directly accessible from the outside of the cloud provider infrastructure.

3. The method according to claim 1, wherein the communication session is or corresponds to a protocol data unit (PDU) session; and/or
wherein the control plane function is or corresponds to the session management function or a session management function instance.

4. The method according to claim 1, wherein—after provisioning or establishing the data network—the data network and the further network as well as its target network identifier information are assigned to each other;
wherein especially such assigning is stored in a repository entity or functionality of the telecommunications network;
wherein especially such assigning is performed:
prior to the first step, or
subsequent to the first step, especially subsequent to the third step.

5. The method according to claim 1, wherein the data network and the further network and/or the data network name and its target network identifier information are assigned to each other, wherein such assigning as well as the provisioning or establishing of the data network is performed subsequent to the first step, especially subsequent to the third step.

6. The method according to claim 1, wherein the cloud provider infrastructure comprises a cloud controller entity or functionality and/or a cloud ingress router entity or functionality, wherein provisioning or establishing the data network and/or assigning or associating the data network, the further network and its target network identifier information involves contacting, by the telecommunications network, the cloud controller entity or functionality and/or the cloud ingress router entity or functionality.

7. The method according to claim 1, wherein the target network identifier information is or corresponds to or comprises a universally unique identifier information of the further network;
wherein especially the target network identifier information comprises an infrastructure identifier information relating to the cloud provider infrastructure, or identifying the cloud provider infrastructure.

8. A user equipment for being operated with a telecommunications network, wherein the user equipment is configured to request, while being connected to the telecommunications network, to be connected to or to access a further network, the further network being a virtual network as part of a cloud provider infrastructure and the further network being accessible, from within the cloud provider infrastructure, using a target network identifier information,
wherein, in order for the user equipment to use or to get access to the further network, a data network and associated data network name is required to be provisioned or established at the telecommunications network or between the telecommunications network and the cloud provider infrastructure,
wherein, in order for the user equipment to be connected to or to access the further network, the user equipment is configured such that:
the user equipment requests a communication session to be established to or towards the further network, using the target network identifier information as part of a request message being transmitted, by the user equipment, to the control plane function of the telecommunications network;
the user equipment receives a communication session establishment accept message, transmitted by the control plane function of the telecommunications network; and
the user equipment uses the established communication session to access the further network via the user plane function of the telecommunications network after the communication session is associated to the data network and/or data network name in order to provide connectivity towards the further network via the cloud provider infrastructure using the data network.

9. A system or telecommunications network for using a user equipment with the telecommunications network, wherein the user equipment requests, while being connected to the telecommunications network, to be connected to or to access a further network, wherein the telecommunications network comprises a control plane function and a user plane function, wherein the further network is a virtual network as part of a cloud provider infrastructure,
wherein the further network is accessible, from within the cloud provider infrastructure, using a target network identifier information,
wherein, in order for the user equipment to use or to get access to the further network, a data network and associated data network name is required to be provisioned or established at the telecommunications network or between the telecommunications network and the cloud provider infrastructure,
wherein, in order for the user equipment to be connected to or to access the further network, the system or telecommunications network is configured such that:
the telecommunications network receives, from the user equipment, a request message regarding a communication session to be established to or towards the further network, the target network identifier information being part of the request message received by the control plane function of the telecommunications network;
the communication session is associated to the data network and/or data network name in order to provide connectivity towards the further network via the cloud provider infrastructure using the data network;
the control plane function of the telecommunications network transmits, and the user equipment receives, a communication session establishment accept message; and
the established communication session is used, by the user equipment, to access the further network via the user plane function of the telecommunications network.

10. A program comprising a computer readable program code which, when executed on a computer and/or on a user equipment and/or on a network node of a telecommunications network, especially a control plane function, or in part on the user equipment and/or in part on the network node of a telecommunications network, especially the control plane function, causes the computer and/or the user equipment and/or the network node of the telecommunications network to perform the method according to claim 1.

11. A computer-readable medium comprising instructions which when executed on a computer and/or on a user equipment and/or on a network node of a telecommunications network, especially a control plane function, or in part on the user equipment and/or in part on the network node of a telecommunications network, especially the control plane function, causes the computer and/or the user equipment and/or the network node of the telecommunications network to perform the method according to claim 1.
